(19) United States
(12) Patent Application Publication
(10) Pub. No.: US 2002/0141725 A1
(43) Pub. Date: Oct. 3, 2002

(54) Fiber pigtail template assembly

(75) Inventors: Robert Harr, Arvada, CO (US); Andrew D. Sappey, Lakewood, CO (US); Michel Cuypers, Longmont, CO (US); Rui Pu, Lafayette, CO (US)

Correspondence Address: SWANSON & BRATSCHUN L.L.C., 1745 SHEA CENTER DRIVE, SUITE 330, HIGHLANDS RANCH, CO, 80129, US

(73) Assignee: Zolo Technologies, Inc.

(21) Appl. No.: 10/099,878

(22) Filed: Mar. 15, 2002

Related U.S. Application Data
(60) Provisional application No. 60/276,769, filed on Mar. 16, 2001.

(51) Int. Cl. G02B 6/36; G02B 6/00

(52) U.S. Cl. 385/137; 385/80; 385/83

(57) ABSTRACT

A fiber pigtail template assembly includes first and second silicon wafers each having a planar surface with a plurality of corresponding grooves therein extending from a leading edge toward a trailing edge. The plurality of corresponding grooves, with the planar surfaces in abutment and the corresponding grooves aligned define a plurality of fiber channels. The first and second silicon wafers further cooperatively define a receptacle between the fiber channels and the trailing edges of the first and second silicon wafers with the planar surfaces of the silicon wafers in abutment with the grooves aligned. A minor diameter leading portion of an optical fiber is received in each fiber channel and the receptacle is sized to receive major diameter trailing portions of each fiber without causing a bending radius of the fiber sufficient to materially degrade wavelength propagation.

### RELATED APPLICATIONS

This application claims priority from U.S. Provisional Patent Application Serial No. 60/276,769, filed Mar. 16, 2001, entitled “Fiber Pigtail Template Assembly” which is incorporated herein in its entirety.

### TECHNICAL FIELD

The present invention is directed toward optical communications, and more particularly toward a fiber pigtail template assembly that may be used, for example, in a bulk optical multiplexer/demultiplexer.

### BACKGROUND ART

At the inception of fiber optic communications, typically a fiber was used to carry a single channel of data at a single wavelength. Dense wavelength division multiplexing (DWDM) enables multiple channels at distinct wavelengths within a given wavelength band to be sent over a single mode fiber, thus greatly expanding the volume of data that can be transmitted per optical fiber. The wavelength of each channel is selected so that channels do not interfere with each other and the transmission losses of the fiber are minimized. While typical DWDM allows up to 40 channels to be simultaneously transmitted by a fiber, there is an ongoing effort to further increase the number of channels transmitted for a given wavelength by an optical fiber.

DWDM requires two conceptually symmetric devices: a multiplexer and a demultiplexer. A multiplexer takes multiple beams or channels of light, each at a discrete wavelength and from a discrete source and combines the channels into a single multichannel or multiplexed beam. The input is typically a linear array of single channel waveguides such a linear array of optical fibers. The output is typically a single multichannel waveguide such as an optical fiber. A demultiplexer spatially separates a multiplexed beam into separate channels according to wavelength. Input is typically a single multichannel input waveguide or fiber and the output is typically a linear array of single channel waveguides such as optical fibers. Collective multiplexers and demultiplexers will be referred to as a “(de)multiplexer” herein.

U.S. patent application Ser. No. 09/634,619 entitled “Echelle Grating Dense Wavelength Division Multiplexer/Demultiplexer with Two Dimensional Single Channel Array,” filed Jul. 29, 2000, now U.S. Pat. No. 6,304,692 (the '692 patent) which is incorporated herein in its entirety, discloses one embodiment of a (de)multiplexer wherein the multichannel waveguide is an optical fiber and single channel waveguides are all optical fibers. In order to maintain alignment of the single channel and multichannel fibers necessary for coupling of light into and from the fibers, the fibers must be maintained in a precise spatial orientation. An assembly of aligned fibers is commonly referred to as a fiber pigtail array. Critical to maintaining the fibers in proper orientation is a fiber template. As disclosed in the '692 patent, one known structure for the pigtail fiber template is a pair of silicon wafers with V-grooves precisely located and etched therein maintain the fibers in a necessary select orientation. With a limited number of fibers, the structure as shown in FIGS. 4-6 of the '692 patent provides acceptable results. However, as more and more channels are loaded on a single fiber requiring the multiplexing of greater numbers of channels, more and more fibers must be incorporated into the fiber pigtail array. In addition, there is a need to minimize the size of optical components. Thus, while spacing of single channel fibers of 125 microns or more may now be an industry norm, smaller and smaller spacings (e.g. 80 or 40 microns or less) are likely to follow, further compacting the space within which multiple fibers must be accommodated. Because each fiber consists of a core, surrounding cladding and a protective coating, each of increasing diameter, space constraints are rapidly taxing the ability of conventional silicon templates to accommodate the ever growing number of fibers incorporated in the arrays. The problem is exacerbated by the fact that the fibers themselves are relatively brittle and excessive bend radiuses in the fibers (typically less than 0.5 inches in radius) can significantly degrade wavelength accuracy and lead to increased insertion losses. While the large bend radiuses could easily be accommodated if there were no space constraints, users demand compact (de)multiplexers, which dictates that the size of the fiber pigtail template assembly be maintained at a minimum. Other factors in a fiber pigtail template assembly not adequately addressed by the prior art have been found to cause stress induced birefringence, contributing to degradation of wavelength accuracy and increased polarization dependent loss. These include subjecting fibers of the assembly to unbalanced, excessive compression when the silicon wafers are epoxied together and overly rigid connection of the optical fibers to the fiber pigtail template assembly.

The present invention is directed toward overcoming one or more of the problems discussed above.

### SUMMARY OF THE INVENTION

A first aspect of the present invention is a fiber pigtail template assembly consisting of a first and a second silicon wafer. Each silicon wafer has a planar surface with a plurality of grooves defining an array therein. The plurality of grooves terminate along a leading edge of the respective first or second silicon wafer and extend toward a trailing edge of the silicon wafer. With the planar surfaces of the first and second silicon wafers abutting with their leading edges aligned and the respective plurality of grooves aligned, an array of fiber channels are defined by the plurality of grooves of the first and second silicon wafers. A receptacle is defined by the first and second wafers with the planar surfaces in abutment to define the fiber channels. The receptacle resides between the fiber channels and the trailing edges of the first and second silicon wafers. A plurality of optical fibers each having a minor diameter leading portion and a major diameter trailing portion are provided with the minor diameter leading portion of each fiber being received in a fiber channel. The receptacle is sized to receive the major diameter trailing portions of the plurality of fibers without causing a bending radius of the fibers sufficient to materially degrade wavelength propagation. Preferably the bending radius of the fibers is greater than 0.5 inches.

An epoxy may be used to pot the major diameter trailing portions within the receptacle. Such an epoxy is preferably an elastic epoxy that eliminates materially performance degrading stress on the fibers. A spacer is preferably provided on each side of the fiber channels. The spacer is dimensioned to eliminate materially performance-degrading stress on the fibers. The spacer may consist of at least one pair of spacing grooves formed in the planar surfaces of the first and second silicon wafers on each side of the arrays of grooves. The spacing grooves are aligned to define at least one spacing channel on each side of the fiber channels with the planar surfaces of the first and second silicon wafers abutting with their leading edges aligned and their respective plurality of grooves aligned to define fiber channels. A length of optical fiber having a diameter substantially equal to that of the minor diameter portion of the plurality of fibers resides in each spacing channel. A third silicon wafer sandwiching the second wafer between the first and the third silicon wafers may be provided and the third silicon wafer cooperates with the first and second silicon wafers to define the receptacle. The receptacle is preferably defined by a cavity in the first silicon wafer located between the plurality of grooves and the trailing edge of the first silicon wafer and a void in the second silicon wafer between the plurality of grooves and the trialing edge of the second silicon wafer.

A second aspect of the present invention is a method of making a fiber pigtail template assembly including providing a pair of first and second silicon wafers each having a planar surface with a plurality of corresponding grooves therein extending from a leading edge toward a trailing edge. The plurality of corresponding grooves define a plurality of fiber channels with the planar surfaces in abutment and the corresponding grooves aligned. The first and second wafers further cooperatively define a receptacle between the fiber channels and the trailing edges of the first and second silicon wafers with the planar surfaces of the silicon wafers in abutment with the grooves aligned. Also provided are a plurality of optical fibers each having a minor diameter leading portion and a major diameter trailing portion. The minor diameter leading portion of each optical fiber is placed in a groove of one the first and second silicon wafers. The minor diameter portion of each optical fiber is secured in a fiber channel by abutting the planar surfaces of the first and second silicon wafers with corresponding grooves aligned to define the plurality of fiber channels. The major diameter portions of the optical fibers are secured in the receptacle without materially degrading wavelength accuracy. The fibers are preferably secured within the receptacle with a bend radius sufficient to not materially degrade wavelength accuracy. The bend radius is preferably greater than or equal to 0.5 inch. The major diameter portions of the fibers are preferably potted in the receptacle using an epoxy elastic enough to eliminate any materially performance degrading stress on the fibers. Preferably spacers are provided on each side of the fiber channels, with the spacers being dimensioned to eliminate performance degrading stress on the fibers.

The fiber pigtail template assembly and method of making the same in accordance with the present invention provides necessary alignment of the optical fibers for effective coupling of optical signals while providing stress relief on fiber transitions that could degrade performance of a (de)multiplexer employing the fiber pigtail template assembly. The fiber pigtail template assembly further provides a compact package for a large number of optical fibers which is critical to minimizing (de)multiplexer size. These many advantages are provided by the fiber pigtail template assembly made of conventional easily fabricated components and therefore the advantages can be enjoyed at minimal cost.

### BRIEF DESCRIPTION OF THE DRAWINGS

FIG. 1 is a perspective view of a fiber pigtail template assembly in accordance with the present invention;

FIG. 2 is an exploded view of the fiber pigtail template assembly of FIG. 1;

FIG. 3A is an enlarged perspective view of the fiber guides in the leading edge of the fiber pigtail template assembly of FIG. 1 with optical fibers disposed therein;

FIG. 3B is a cross-section of an optical fiber;

FIG. 4 is a rear elevational view of the fiber pigtail template assembly of FIG. 1;

FIG. 5 is a cross-section of the fiber pigtail template assembly of FIG. 1 taken along line 5-5 of FIG. 1;

FIG. 6 is an enlarged view of section D of FIG. 5 showing a reduced cladding portion of a fiber disposed within a fiber guide;

FIG. 7 is an enlarged view of section C of FIG. 5 showing a transition between the fiber guide and a cladding chamber along with the transition between a reduced cladding portion of a fiber and the whole cladding portion of the fiber;

FIG. 8 is an enlarged view of section B of FIG. 5 showing a transition between the cladding chamber of the fiber pigtail template assembly and the back of the assembly along with the transition of the full cladding portion of the fiber to a coated portion of the fiber;

FIG. 9 is an enlargement of FIG. 7 having a stack of full cladding portions of fibers and the transition of the reduced cladding portion of the fibers thereto; and

FIG. 10 is an end view of the fiber pigtail template assembly illustrating the stacking of full cladding portion of fibers within the cladding chamber of the fiber pigtail template assembly;

FIG. 11 is a perspective view of an alternative embodiment of a fiber pigtail template assembly;

FIG. 12 is an exploded view of the fiber pigtail template assembly of FIG. 11;

FIG. 13 is a partial cross-section taken along line 13-13 of FIG. 11; and

FIG. 14 is an exploded view of a dual input embodiment of a fiber pigtail template assembly.

### DETAILED DESCRIPTION OF THE PREFERRED EMBODIMENT

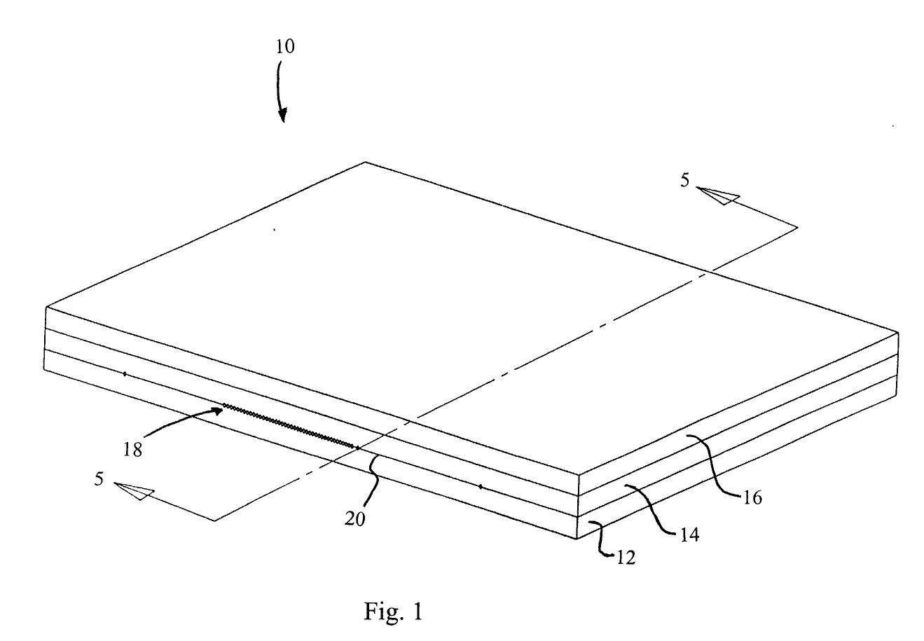

A first embodiment of a fiber pigtail template assembly 10 is shown in a perspective view in FIG. 1. The fiber pigtail template assembly consists of a first or bottom wafer 12, a second or middle wafer 14 and a third or top wafer 16. A plurality of fiber channels 18 defining an array exit at a leading edge 20 of the fiber pigtail template assembly.

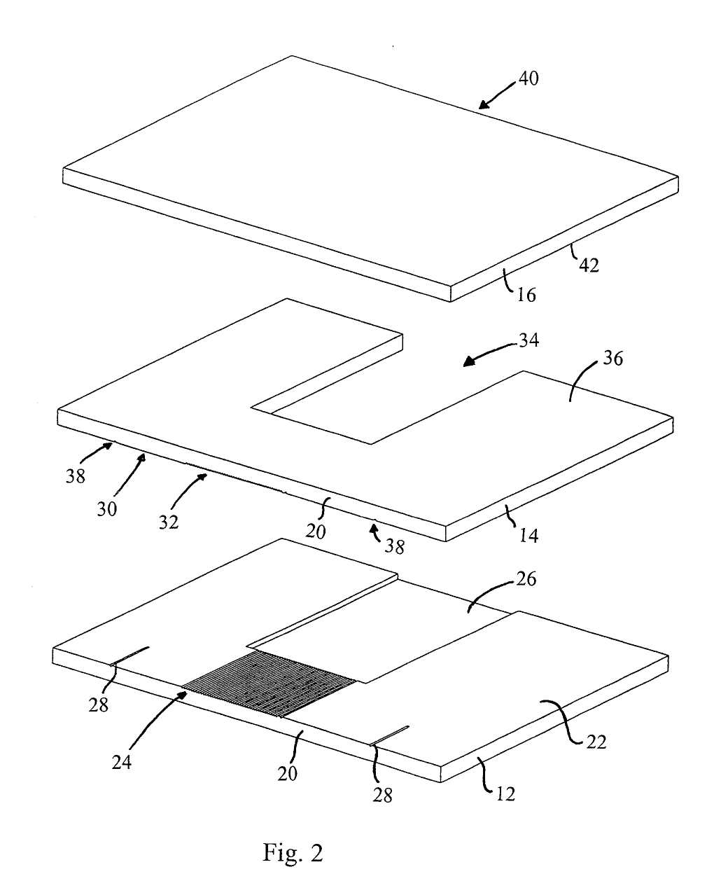

FIG. 2 shows the bottom, middle and top wafers 12, 14, 16 in an exploded view. The bottom wafer 12 has a planar top surface 22 including a plurality of V-shaped channels 24 defining an array extending straight and in parallel between the leading edge 20 and a cavity 26 opening to a trailing edge of the wafer. The bottom wafer 12 and indeed the middle and top wafers 14, 16 as well are preferably formed from silicon and the V-shaped grooves 24 and the cavity 26 are etched in the silicon using conventional techniques. A pair of alignment grooves 28 are also preferably provided in the top surface and breach the leading edge 20.

The middle wafer 14 has a planar bottom surface 30 having a number of V-shaped grooves 32 corresponding to the V-shaped grooves 24 in the bottom wafer 22. These V-shaped grooves are also straight and parallel and extend from the leading edge 20 to a void 34 extending between the bottom planar surface and the top planar surface 36 of the middle wafer 14. The void 34 is the same width and depth as the cavity 26 of the lower wafer 12. Alignment grooves 38 are also formed in the bottom surface 30 and correspond to the alignment grooves 28 in the top surface of the lower wafer 12.

The middle wafer preferably has a same width and depth as the bottom wafer 12. The top wafer 16 preferably also has the same width and depth as the bottom wafer 12 but lacks the alignment grooves 28 and the V-grooves 24. However, a cavity 40 is formed in a bottom surface 42 of the top wafer 16 that has a same width and depth as the cavity 26 (see FIG. 4). Collectively, the cavity 26, the void 34 and the cavity 40 define a receptacle for optical fibers 42 and 44.

As illustrated, the middle wafer is essentially a single horseshoe shaped piece. Alternatively, the middle wafer could be three rectangular pieces, consisting of a piece having the V-shaped grooves and two trailing pieces all sandwiched between the bottom and top wafers. It is preferred to have the middle wafer include some spacer at the back of the assembly to prevent the top or bottom wafers from cracking just beyond the end of the V-shaped grooves.

The top wafer 16 both adds structural rigidity to the middle wafer and the wafer assembly as a whole and provides for a larger receptacle formed by the aligned pockets and voids of the top, bottom and middle wafers. The receptacle facilitates sealing of the assembly to isolate the exposed fiber core from air (moisture) that is extremely detrimental to the life of the fibers. Alternatively, as described with respect to the second embodiment, the top wafer 16 can be omitted and fibers received in the receptacle can be potted in an epoxy.

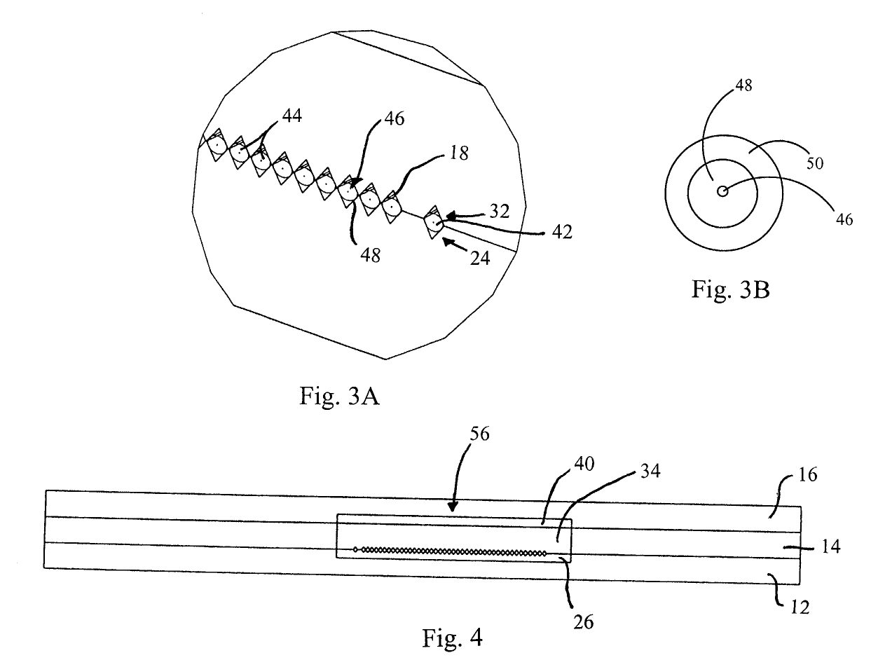

The template assembly 10 is assembled with the middle wafer 14 sandwiched between the bottom and top wafers 12 and 16 and the V-grooves 24 aligned with the V-grooves 34. Alignment grooves 28, 38 can be used for facilitating alignment. The wafers are held together by means of a suitable adhesive, preferably an epoxy. When assembled V-shaped grooves 24, 32 form diamond shaped fiber channels 18 as best seen in FIG. 3A. Prior to assembling the wafers, multichannel fiber 42 and the array of single channel fibers 44 are arranged in the V-shaped grooves 24 of the bottom wafer as illustrated FIG. 3A. In one embodiment of the fiber pigtail template assembly, the multichannel fiber 42 resides in the same plane as the single channel fibers 44. Other embodiments are possible where the multichannel fiber may lie in a plane above or below the single channel fibers 44. As illustrated in FIG. 3, the single channel fibers appear to be equally spaced. In actuality, the distance between adjacent single channel fibers increases from right to left as depicted in FIG. 3. For example, the first pair may be separated by a distance of about 85 microns whereas the left most pair may be separated by a distance of about 94 microns. This is necessitated by the non-linear dispersion of diffraction gratings.

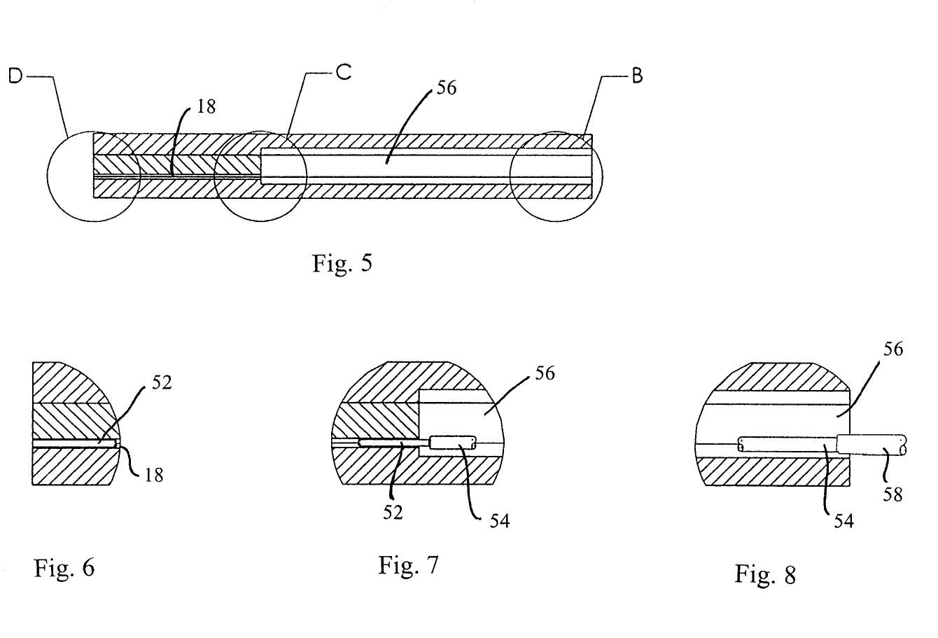

The fiber ends viewed in FIG. 3A consist of a fiber core 46 and cladding layer 48. Referring to FIG. 3B, typically a fiber consists of a core 46, a cladding layer 48 and a coating 50. Typically the cladding layer 48 has a diameter of about 125 microns and the coating has a diameter of about 155-250 microns. In order for the fiber cores 46 to have small enough spacing at the input ends illustrated in FIG. 3A, the coating 50 must be removed and the cladding 48 must be etched to a diameter of about 80 microns, with diameters as little as 40 microns or smaller being foreseeable. Currently fibers having a cladding with a diameter of about 80 microns and a coating diameter of about 250 microns are available, which in embodiments requiring an 80 micron cladding diameter eliminates the need for further etching of the cladding. The V-shaped grooves are sized and spaced accordingly to accommodate the selected diameter of the clad fibers. Referring to FIG. 5-8, a single fiber having a reduced cladding portion 52 and a full cladding portion 54 is illustrated deployed in the fiber pigtail assembly 10. The reduced cladding portion 52 is deployed in the fiber channel 18 (FIG. 6) and a fall cladding portion 54 resides in the receptacle 56 formed by the bottom cavity, the void 34 and the top pocket 40 (see FIG. 7). As the full cladding portion of the fiber 54 approaches the mouth of the cladding chamber 56 it transitions to the coated portion 58 of the fiber having the greatest external diameter.

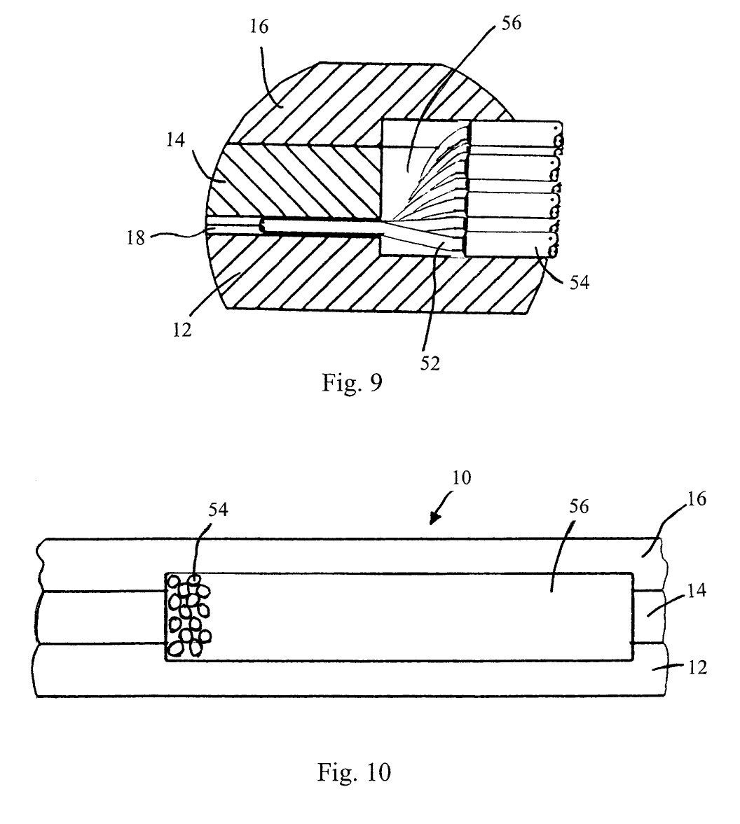

The use of the three wafer assembly as disclosed herein allows for an enlarged receptacle 56. More particularly, the middle wafer 14 having the void 34 allows the receptacle 56 to be of increased height without requiring excessive etching of the top and bottom wafers, which would be both time consuming and expensive. As a result, a much larger number of fibers can be accommodated by the fiber pigtail template assembly. Referring first to FIG. 9, the full cladding portion 54 of the fibers can be stacked within the receptacle while still allowing the reduced cladding portions 52 to maintain a bending radius transitioning to the full cladding portions sufficient to prevent material degradation of wavelength propagation. As used herein, “degradation of wavelength propagation” or “degrade wavelength propagation” means degradation of wavelength accuracy and insertion loss. For telecommunications and data transmission in a fiber optic network, (de)multiplexers must minimize degradation of wavelength accuracy and insertion loss. The inventors have found this to require the fiber pigtail template assembly to limit degradation of wavelength accuracy to no more than ±15 picometers and to limit the insertion loss to no more than 0.1 db to avoid “material” degradation of wavelength propagation. Maintaining a bending radius of at least 0.5 inches has been found to prevent material degradation of wavelength propagation.

FIG. 10 further shows how the fall cladding portions can be stacked. The increased height of the receptacle 56 will allow the pigtail assembly to accommodate 40, 80 and even more fibers as the number of channels packed onto a multichannel fiber increases.

It should also be appreciated that while the first embodiment disclosed herein shows the single multichannel fiber and the single channel fibers arranged in a linear array, the multiplexer as described in the '692 patent could also accommodate two or more rows of fiber arrays. The present invention could be extended to template assemblies wherein the upper surface 36 of the middle wafer 14 and the bottom surface 42 of the top wafer 16 each have V-shaped grooves defining fiber guides. In this instance, the fiber count would be further increased and the multi-layer wafer assembly defining a receptacle 56 of increased height would be extremely useful in accommodating the large number of fibers. Representative dimensions of the receptacle would be 600 microns high by 10 millimeters wide.

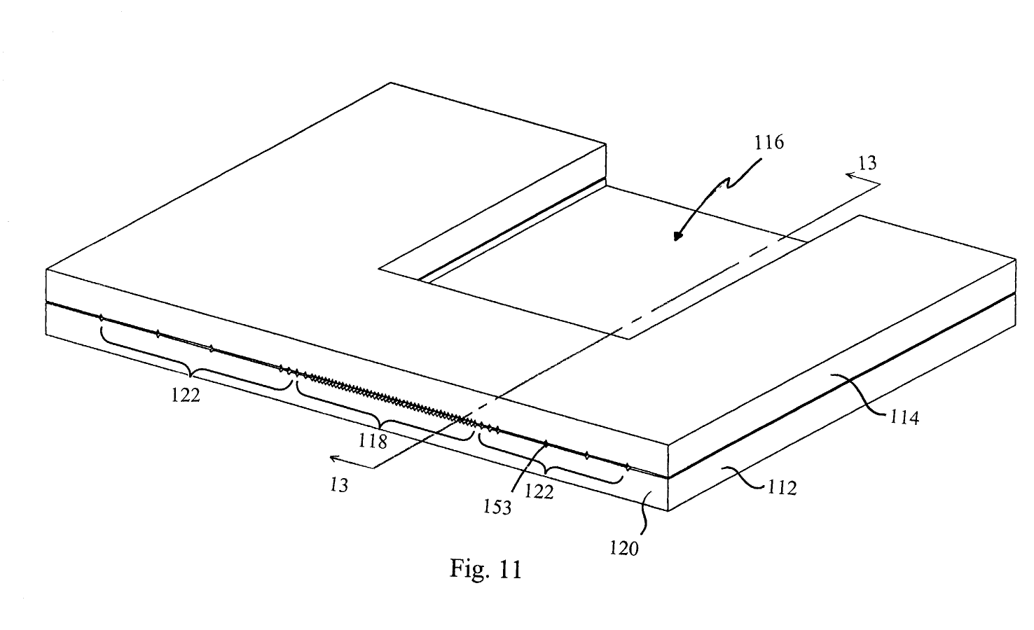

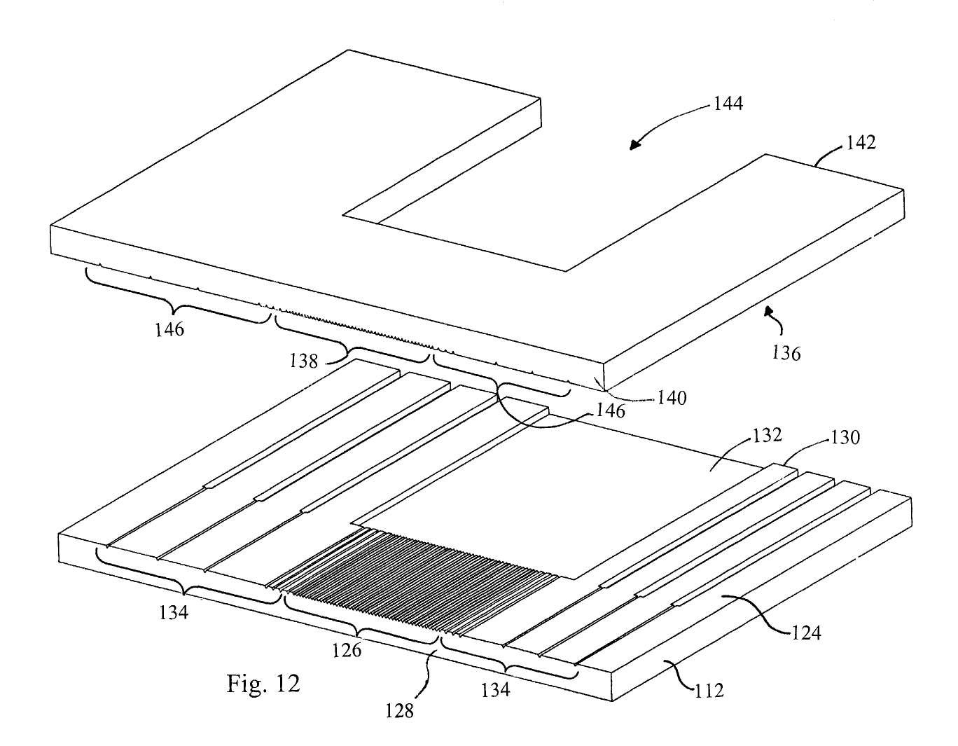

FIGS. 11-13 illustrate a second embodiment of the fiber pigtail template assembly 110. The second embodiment may be used with the fibers described above and made of the same materials and by the same processes discussed above, except with the structural differences discussed below. The second embodiment consists of a first or bottom silicon wafer 112 and a second or top silicon wafer 114. As with the first embodiment, a plurality of fiber channels 118 define an array exiting at a leading edge 120 and into a receptacle 116 of the fiber pigtail assembly 110. This embodiment also includes a number of spacing channels 122 on either side of the channel array 118.

Referring to FIG. 12, the bottom silicon wafer 112 has a top planar surface 124 having a plurality of V-shaped fiber grooves 126 deployed in an array terminating along a leading edge 128 of the bottom silicon wafer and extending toward a trailing edge 130. A cavity 132 is etched in the planar surface 124 and resides between the fiber grooves 126 and the trailing edge 130 of the bottom silicon wafer 112. A number of V-shaped spacing grooves 134 extend parallel to the fiber grooves 126 on either side of the array of fiber grooves and are spaced along substantially the entire width of the bottom silicon wafer 112. The V-shaped spacing grooves transition to square-shaped parallel to the cavity 132.

The top silicon wafer 114 has a planar bottom surface 136 having a complimentary array of fiber grooves 138 terminating along a leading edge 140 of the top silicon wafer and extending toward a trailing edge 142. A void 144 is formed in the top wafer between the fiber grooves 138 and the trialing edge 142 of the top silicon wafer. The fiber grooves 138 of the top silicon wafer are formed to correspond to the fiber grooves 126 of the bottom silicon wafer such that when they are aligned they define the fiber channels 118 as illustrated in FIG. 1. V-shaped spacing grooves 146 are also formed in the planar surface 136 of the top silicon wafer 114 and these run parallel to the fiber grooves 138. These also transition to a square shape like the spacing grooves 134. The spacing grooves 146 are spaced along the width of the top silicon wafer 114 such that they correspond with the spacing grooves 134 formed in the planar surface 124 of the bottom silicon wafer 112 and cooperate to define the spacing channels 122 illustrated in FIG. 11. When assembled as illustrated in FIG. 11, the void 144 and the cavity 132 combine to define the receptacle 116.

The second embodiment receives fibers 42, 44 in generally the same way as the first embodiment as illustrated in FIGS. 3A-8. One obvious difference is the second embodiment does not include what is referred to as the top silicon wafer 16 of the first embodiment. Thus, the receptacle 116 has an open top.

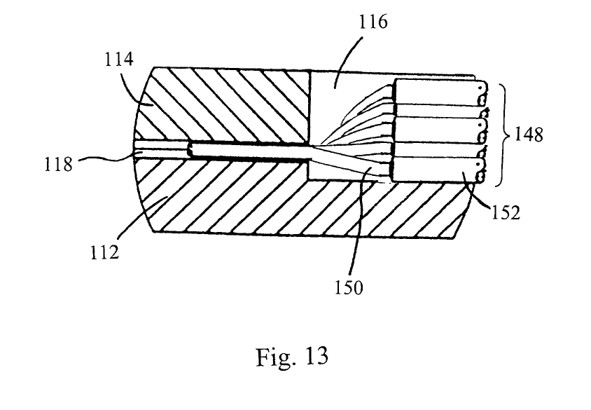

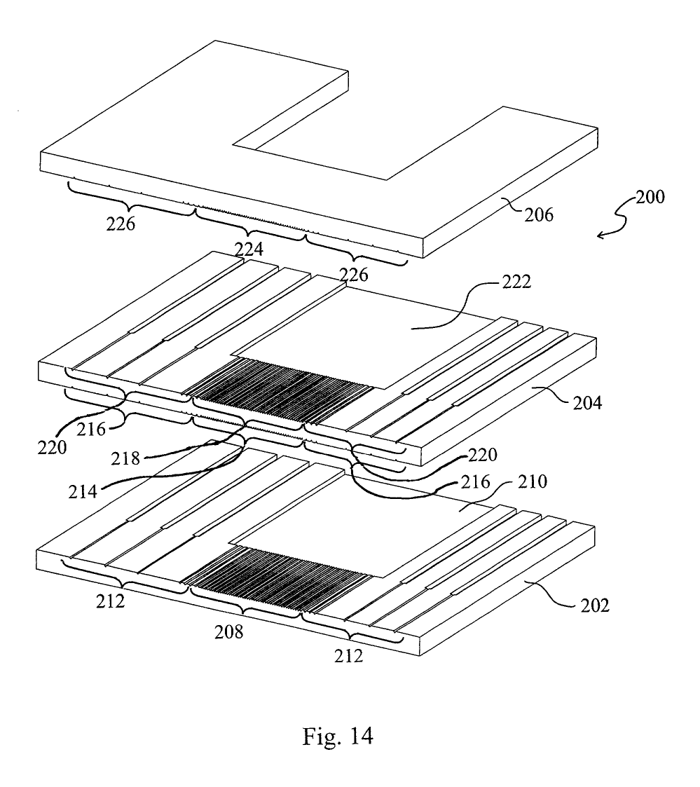

FIG. 13 illustrates deployment of fibers 148 in the receptacle 116. In the embodiment illustrated in FIG. 13, the fibers 148 have a clad length 150 defining a minor diameter leading portion and a coating length defining a major diameter trailing 152 portion deployed with the minor diameter leading portion of each fiber 148 in a fiber channel 118 of the fiber pigtail template assembly. As with the first embodiment, the fibers are stacked within the receptacle to maintain a bending radius transitioning between the minor diameter portion and the major diameter portion sufficient to prevent material degradation of wavelength propagation. In this embodiment, the fibers 148 are potted by an epoxy within the receptacle 116. The potting epoxy both maintains the fibers within the receptacle 116 and provides structural stress protection to the fibers 148. The potting epoxy further serves to isolate the exposed fiber core from air (moisture). The preferred epoxy is a elastic epoxy such as Epotek OE107 or TE109 that is chosen to prevent materially performance degrading stress on the fibers. As used herein, “performance degrading stress on the fibers” means excessive stress induced birefringence in the fibers. Stress induced birefringence degrades accuracy and induces polarization dependent loss. For telecommunications and data transfer in a fiber optic network, components such as (de)multiplexers must minimize stress induced birefringence. The inventors have found that the fiber pigtail assembly must degrade the wavelength accuracy no more than ±15 picometers and the polarization dependent loss can be no more than 0.1 db to avoid “material” performance degrading stress on the fibers.

The fibers 148 illustrated in FIG. 9 have a clad minor diameter leading portion having a diameter of about 80 microns. The coated major diameter leading portion has a diameter of about 250 microns. Obviously, the specific diameters of the minor diameter leading portion and the major diameter trailing portion are a function of the channel separation requirements of the (de)multiplexer.

Deployed within the spacing channels 122 are lengths of fiber 153 (as shown in FIG. 11) having substantially the same outer diameter as the minor diameter leading portion 150 of the fibers 148. These fibers cooperate with the grooves to define spacers on each side of the fiber channels dimensioned and spaced to eliminate materially performance degrading stress on the fibers. Absent the spacers defined by the spacing channels 122 and the fibers 153 received therein, the fibers 148, particularly those at the ends of the array, would be subjected to excessive stress resulting from compression forces on the top and bottom silicon wafers 112 and 114 caused by an epoxy used to hold the wafers together.

FIG. 14 is an exploded view of a dual input fiber pigtail template 200. This embodiment includes a bottom silicon wafer 202, a middle silicon wafer 204 and a top silicon wafer 206. The bottom silicon wafer has a top surface including a plurality of V-shaped grooves 208, a cavity 210 and V-shaped spacing grooves 212 identical to the bottom silicon wafer 112 discussed with respect to FIG. 12. The middle silicon wafer 204 has a bottom surface with plurality of V-shaped grooves 214, a bottom cavity (not visible), and a plurality of V-shaped spacing grooves 216 configured to mate with corresponding V-shaped fiber grooves, V-shaped spacing grooves 212 and the cavity 210 of the bottom wafer 202 as described above with reference to FIGS. 11 and 12. The top surface of the middle silicon wafer 204 likewise includes a plurality of V-shaped fiber grooves 218 and V-shaped spacing grooves 220 as well as a cavity 222. The bottom surface of the top wafer 206 has a corresponding plurality of V-shaped grooves 224, spacing grooves 226 and a cavity corresponding to the cavity 222. The bottom surface of the top wafer 226 and the top surface of the middle wafer 224 mate in the same manner as the top surface of the bottom wafer 202 and the bottom surface of the middle wafer 204 to define fiber channels, spacing channels and a receptacle.

While the embodiment discussed with reference to FIG. 14 would be suitable for use with a dual input (de)multiplexer, a three or more input multiplexer could be accommodated simply by adding additional wafers with the tops and/or bottom surfaces etched with grooves and cavities in the manner discussed with respect to FIG. 14. Also, it should be readily apparent that the embodiment of FIG. 14 is intended to receive optical fibers having a minor diameter leading portion and major diameter trailing portion as discussed above with respect to the other embodiments. The major diameter trailing portions would preferably be potted in a flexible epoxy as discussed above. Also, the spacing grooves are intended to receive portions of fiber having the same outer diameter as the minor diameter leading portion of the fiber to provide proper spacing as discussed above with respect to the embodiment shown in FIGS. 11-13.

The fiber pigtail template assembly of the present invention provides a structure that maintains optical fibers in precise alignment while minimizing stress on the optical fibers coupled to the fiber pigtail template assembly. Use of a properly dimensioned receptacle allows for maintenance of bending radii in the fiber transition regions that prevents material degradation of wavelength propagation. Use of a elastic epoxy to pot the fibers prevents materially performance degrading stress on the fiber transitions. Use of the spacers defined by the spacing grooves receiving fiber segments further eliminates materially performance degrading stress on the fibers. These many advantages are provided in a fiber pigtail template assembly made of conventional materials that can be machined and assembled inexpensively.

1. A fiber pigtail template assembly comprising:
a first silicon wafer having planar surface with a first plurality of grooves defining a first array therein, the first plurality of grooves terminating along a leading edge of the first silicon wafer and extending toward a trailing edge of the first silicon wafer;
a second silicon wafer having a planar surface with a second plurality of grooves defining a second array, the second plurality of grooves terminating along a leading edge of the second silicon wafer and extending toward a trailing edge of the second silicon wafer, the planar surfaces of the first and second silicon wafers abutting with their leading edges aligned and the first and second plurality of grooves aligned to define fiber channels; and
a receptacle defined by the first and second wafers with the planar surfaces in abutment to define the fiber channels, the receptacle being between the fiber channels and the trailing edges of the first and second silicon wafers.

2. The fiber pigtail template assembly of claim 1 where the grooves are V-shaped, the assembly further comprising:
a plurality of optical fibers each having a minor diameter leading portion and a major diameter trailing portion, the minor diameter leading portion of each fiber being received in a fiber channel, the receptacle being sized to receive the major diameter trailing portions of the plurality of fibers without causing a bending radius of the fibers sufficient to materially degrade wavelength propagation.

3. The fiber pigtail template assembly of claim 2 wherein the bending radius of the fibers is greater than or equal to 0.5 inch.

4. The fiber pigtail template assembly of claim 2 further comprising an epoxy securing the first and second wafers in abutment.

5. The fiber pigtail template assembly of claim 2 further comprising an epoxy potting the major diameter trailing portions within the receptacle.

6. The fiber pigtail template assembly of claim 5 where in the epoxy is an elastic epoxy that eliminates materially performance degrading stress on the fibers.

7. The fiber pigtail template assembly of claim 2 further comprising a spacer on each side of the fiber channels, the spacer being dimensioned to eliminate materially performance degrading stress on the fibers.

8. The fiber pigtail template assembly of claim 7 wherein the spacer comprises at least one pair of V-shaped spacing grooves formed in the planar surfaces of the first and second silicon wafers on each side of the first and second array of grooves, the spacing grooves being aligned to define at least one spacing channel on each side of the fiber channels with the planar surfaces of the first and second silicon wafers abutting with their leading edges aligned and the first and second plurality of grooves aligned to define fiber channels.

9. The fiber pigtail template assembly of claim 8 further comprising a length of optical fiber having a diameter substantially equal to that of the minor diameter portion of the plurality of fibers residing in each spacing channel.

10. The fiber pigtail template assembly of claim 2 further comprising a third silicon wafer sandwiching the second wafer between the first and third silicon wafers, the third silicon wafer cooperating with the first and second silicon wafers to define the receptacle.

11. The fiber pigtail template assembly of claim 2 wherein the first silicon wafer has a cavity defined between the first plurality of grooves and the trailing edge of the first silicon wafer and the second silicon wafer has a void between the second plurality of grooves and the trailing edge of the second silicon wafer, the cavity and the void cooperating to define the receptacle.

12. A method of making a fiber pigtail template assembly comprising:
a) providing a pair of first and second silicon wafers each having a planar surface with a plurality of corresponding grooves therein extending from a leading edge toward a trailing edge, the plurality of corresponding grooves, with the planar surfaces in abutment and the corresponding grooves aligned, defining a plurality of fiber channels, the first and second silicon wafers further cooperatively defining a receptacle between the fiber channels and the trailing edges of the first and second silicon wafers with the planar surfaces of the silicon wafers in abutment with the grooves aligned;
b) providing a plurality of optical fibers each having a minor diameter leading portion and a major diameter trailing portion;
c) placing the minor diameter leading portion of each optical fiber in a groove of one of the first or second silicon wafers;
d) securing the minor diameter portion of each optical fiber in a fiber channel by abutting the planar surfaces of the first and second silicon wafers with the corresponding grooves aligned to define the plurality of fiber channels; and
e) securing the major diameter portions of the optical fibers in the receptacle without materially degrading wavelength accuracy.

13. The method of making a fiber pigtail template assembly of claim 12 wherein step e) comprises placing the major diameter portions of the optical fibers in the receptacle with each optical fiber having a bending radius sufficient to not materially degrade wavelength accuracy.

14. The method of making a fiber pigtail template assembly of claim 13 wherein the bending radius is greater than or equal to 0.5 inch.

15. The method of making a fiber pigtail template assembly of claim 12 wherein step e) comprises potting the major diameter portions of the fibers in the receptacle using an epoxy elastic enough to eliminate any materially performance degrading stress on the fibers.

16. The method of making a fiber pigtail template assembly of claim 12 further comprising providing a spacer on each side of the fiber channels, the spacer being dimensioned to eliminate performance degrading stress on the fibers.

17. A fiber pigtail template assembly comprising:
a first silicon wafer having planar surface with a first plurality of V-shaped grooves defining a first array therein, the first plurality of grooves terminating along a leading edge of the first silicon wafer and extending toward a trailing edge of the first silicon wafer;
a second silicon wafer having a planar surface with a second plurality of V-shaped grooves defining a second array, the second plurality of grooves terminating along a leading edge of the second silicon wafer and extending toward a trailing edge of the second silicon wafer, the planar surfaces of the first and second silicon wafers abutting with their leading edges aligned and the first and second plurality of grooves aligned to define fiber channels;
a plurality of optical fibers each having a minor diameter leading portion and a major diameter trailing portion, the minor diameter leading portion of each fiber being received in a fiber channel;
a receptacle defined by the first and second wafers with the planar surfaces in abutment to define the fiber channels, the receptacle being between the fiber channels and the trailing edges of the first and second silicon wafers, the receptacle being sized to receive the major diameter trailing portions of the plurality of fibers without causing a bending radius of the fibers sufficient to materially degrade wavelength accuracy; and
an epoxy potting the major diameter trailing portions within the receptacle, the epoxy being suitably elastic to eliminate materially performance degrading stress on the fibers.

18. The fiber pigtail template assembly of claim 17 further comprising a spacer on each side of the fiber channels, the spacer being dimensioned to eliminate performance degrading stress on the minor diameter portion of the fibers.

19. The fiber pigtail template assembly of claim 18 wherein the spacer comprises at least one pair of V-shaped spacing grooves formed in the planar surfaces of the first and second silicon wafers on each side the first and second array of grooves, the spacing groves being aligned to define at least one spacing channel on each side of the fiber channels with the planar surfaces of the first and second silicon wafers abutting with their leading edges aligned and the first and second plurality of grooves aligned to define fiber channels and a length of optical fiber having a diameter substantially equal to that of the minor diameter portion of the plurality of fibers residing in each spacing channel.

20. The fiber pigtail template assembly of claim 17 further comprising a third silicon wafer sandwiching the second wafer between the first and third silicon wafers, the third silicon wafer cooperating with the first and second silicon wafers to define the receptacle.

21. The fiber pigtail template assembly of claim 17 wherein the first silicon wafer has a cavity defined between the first plurality of grooves and the trailing edge of the first silicon wafer and the second silicon wafer has a void between the second plurality of grooves and the trailing edge of the second silicon wafer, the cavity and the void cooperating to define the receptacle.
